(19) United States
(12) Patent Application Publication
(10) Pub. No.: US 2008/0044508 A1
(43) Pub. Date: Feb. 21, 2008

(54) Operating Machine Provided with a Plurality of Actuators, Apparatuses and Control System

(75) Inventors: Alessandro Balboni, Granarolo dell'Emilia (BO) (IT); Fiorenzo Parrinello, Medicina (BO) (IT)

Correspondence Address: NIXON & VANDERHYE, PC, 901 NORTH GLEBE ROAD, 11TH FLOOR, ARLINGTON, VA, 22203, US

(73) Assignee: SACMI COOPERATIVA MECCANICI IMOLA SOCIETA COOPERATIVA, Imola (BO) (IT)

(21) Appl. No.: 11/663,542

(22) PCT Filed: Sep. 22, 2005
(86) PCT No.: PCT/EP05/10269

§ 371 Date: Apr. 24, 2007

(30) Foreign Application Priority Data
Sep. 24, 2004 (IT) MO2004A000248

(51) Int. Cl. B29C 43/58

(52) U.S. Cl. 425/155

(57) ABSTRACT

An apparatus for moulding plastics comprises a mould device, an actuating system arranged to move said mould device and a shock-absorbing device interposed between said actuating system and said mould device, said actuating system comprising an electromechanical actuating system; an apparatus for moulding plastics comprises mould device and an actuating system arranged to move said mould device, said actuating system comprising an electromechanical actuating system provided with an electric motor unit and with a control system for controlling an electrical parameter of said electric motor unit; an operating machine comprises a plurality of actuating devices suitable for operating an operating unit, at least one control unit for controlling said actuating devices and a switching device arranged to selectively connect said at least one control unit to at least actuating device of said plurality of actuating devices.

The present invention relates to an operating machine in which at least one actuator acts, and actuating apparatuses of operating members in an operating machine and a control system of an operating machine.

The invention refers in particular, but not exclusively, to the compression moulding of plastics for obtaining objects such as caps suitable for being associated with containers.

Apparatuses comprising moulds for the compression moulding of plastics are known comprising a die provided with a cavity in which a certain quantity of plastics is inserted in a pasty state, and a punch suitable for compressing the plastic material inside the cavity.

The cavity and the punch are shaped in such a manner as to give the plastics a shape corresponding to the object to be obtained. In particular, in the moulding of stoppers, or lids or caps the die defines an external surface of the object and the punch defines an internal surface of the object.

In order to open and close the mould, the die and the punch are moved towards and away from each other by actuators that may be of a mechanical or hydraulic type.

The hydraulic actuators comprise a cylinder inside which a piston is movable driven by pressurised oil that controls the movement of the punch and/or the die.

A drawback of the hydraulic actuators is that they involve significant system and structural complication, in particular if a plurality of moulds fitted to the same rotatable turntable is provided.

A further drawback of the hydraulic actuators is that they have a follower organ, the speed of which is not easily controllable.

As a result, the obtained caps may have unacceptable drawbacks, for example burrs, due to asymmetrical and non-uniform flows of the plastic in the mould.

A still further drawback of the hydraulic actuators is that it is necessary to constantly control the fluid contained inside them and intervene in the case of losses and/or leaks from the latter.

The use of hydraulic actuators furthermore leads to the risk that a certain quantity of oil may come into contact with the plastics being moulded, for example through an oil leak or through the evaporation of particles of oil into the air surrounding the moulding environment, thereby causing contamination and a possible deterioration to the formed object.

The mechanical actuators may comprise a cam, which controls the movement of the punch or of the die.

The mechanical actuators thus have numerous drawbacks inasmuch as they need very expensive components and require extremely precise assembly of these components.

Furthermore, these actuators are rather stiff because they do not allow simple adjustment of the stroke that the punch, or the die, has to perform and of the speed with which the stroke is performed. This adjustment can in fact be obtained only by replacing parts of the actuators.

The mechanical actuators furthermore greatly suffer from wear to the components that constitute them, so after prolonged operation they tend to be imprecise.

In particular, if the mechanical actuators are worn they are not able to ensure preset pressure between the punch and the die, which may cause undesired escapes of material from the die.

Furthermore, as the mechanical actuators are equipped with a fixed stroke, it is not possible to vary the clamping pressure of the mould according to the properties of the material, in particular of the latter's fluidity.

In addition, as the mechanical actuators do not enable stress of the pulsed type to be avoided, for example blows that may be generated in the mould during moulding, support structures must be provided for the moulds that are robust enough to resist stresses.

Alternatively, shock-absorbing devices can be provided interposed between the actuator and the die and/or the punch that enable the stress to be maintained substantially constant to which the punch, the die and the organs for their operation are subjected.

In particular, if inside the die an excessive dose of pasty plastics is deposited because of incorrect operation of a supply device of the plastics, the shock-absorbing devices prevent the great stress that is generated from damaging, possibly irreparably, the mould.

The shock-absorbing devices furthermore enable to a certain extent differences between the actual stroke and the theoretical stroke of the actuators to be compensated, these differences being for example due to the wear that affects the cams.

The shock-absorbing devices may comprise a pneumatic cylinder interposed between the die and/or the punch and the respective actuator.

The known apparatuses comprise a rotatable turntable to which a plurality of the aforementioned dies is fixed, for example arranged in angularly equidistant positions.

Each mould is operated by an actuator with which a control unit is associated.

Apparatuses are furthermore known in which each mould comprises a punch fixed to a frame of the turntable and a die that is fixed to a movable part of an actuator that moves the die towards and away from the punch. Alternatively, it is also known to fix the die to a part of the frame of the turntable and fix the punch to an actuator.

During operation, each mould is opened in such a way that a formed cap can be extracted from it and a preset quantity of plastics in the pasty state is inserted inside the mould to obtain a further cap.

Subsequently, the mould is closed to obtain the moulding of a cap and the stabilisation of the form of the aforementioned cap.

The aforementioned phases occur whilst the turntable is being rotated.

The phase of extraction of the formed cap and the phase of insertion of the pasty plastics require rather a limited time during which the turntable performs a rotation corresponding to an angle of a few tens of degrees, for example about 20 degrees.

The phases of moulding and stabilisation of the form, on the other hand, occur over a decisively longer time whilst the mould, during rotation of the turntable performs a further angle, substantially explementary to the above angle.

A drawback of the apparatuses disclosed above consists of the fact that they are not very cheap, because of the high cost of the actuators and of the control units arranged to regulate their operation.

An object of the invention is to improve the apparatuses for compression moulding of plastics.

Another object of the invention is to obtain an apparatus for compression moulding of plastics that is rather cheap.

A further object of the invention is to obtain an apparatus for compression moulding of plastics that enables operation of the moulds to be effectively controlled.

In a first aspect of the invention, an operating machine is provided comprising a plurality of actuating devices suitable for driving operating means between a neutral position and an operating position, control means for driving said actuating devices, characterised in that said control means comprises at least a control unit, switching means being provided arranged for selectively connecting said at least a control unit to at least an actuating device of said plurality of actuating devices.

In one embodiment, the actuating devices control the opening and closing of mould means for the compression moulding of plastics.

Owing to this aspect of the invention, it is possible to obtain an apparatus for the compression moulding of plastics having rather a low cost.

In this apparatus, in fact, the use of switching means enables one or more control units to be installed to control a greater number of actuating means rather than one control unit for each actuating device, as occurs in the apparatuses according to the state of the art.

In a second aspect of the invention, an apparatus is provided, comprising die means suitable for receiving plastics to be moulded and punch means cooperating with said die means to mould said plastics, actuating means arranged to bring up and remove said die means and said punch means and shock-absorbing means interposed between said actuating means and said die means and/or said punch means, characterised in that said actuating means comprises electromechanical actuating means. Owing to this aspect of the invention, it is possible to obtain an apparatus for the compression moulding of plastics in which the operation of the die means and/or the punch means can be controlled with great accuracy.

The apparatus is furthermore provided with considerable flexibility inasmuch as the stroke performed by a movable part of the actuating means can be varied with extreme simplicity, for example by acting on electric motor control means with which the electromechanical actuating means is provided.

It is also possible to obtain an apparatus for compression moulding of plastics that enables the modes of operation of the moulds to be controlled and varied by for example intervening on the stroke and/or closing speed and/or moulding pressure.

By intervening on the control means it is thus possible to operate the electromechanical actuating means according to the physical and/or chemical and/or mechanical properties of the plastics used to form the caps and according to the geometrical features of the latter.

Furthermore, owing to the possibility of carrying out fine control of the advance of the movable part of the electromechanical actuating means, the imprecisions caused by wear to the mechanical components are substantially eliminated in such a way as to obtain caps according to the desired dimensional tolerances.

Owing to this aspect, it is furthermore possible to obtain an apparatus that is able to form caps without the risk of contamination of the plastics, for example through leakage of operating fluid, as may occur when hydraulic actuators are used.

In one embodiment, the electromechanical actuating means comprises mechanically irreversible electromechanical actuating means.

In this case, the die means and the punch means can be kept clamped against each other—during the cooling phase of the plastics—without the electric motor means having to be supplied. This enables the mechanical and electronic components not having to be stressed to no purpose during the aforementioned cooling phase, which in fact constitutes the longest temporary phase of the entire operating cycle of the apparatus.

In a third aspect of the invention, an apparatus is provided comprising die means suitable for receiving plastics to be moulded and punch means cooperating with said die means to mould said plastics, actuating means arranged to move said die means and said punch means towards and away from each other, characterised in that said actuating means comprises electromechanical actuating means provided with electric motor means and control means for controlling an electrical parameter of said electric motor means.

In an embodiment, the electromechanical actuating means comprises high-performance electromechanical actuating means, in particular mechanically reversible electromechanical actuating means.

In this embodiment, locking means of the actuating means can be provided.

Owing to this aspect of the invention, by controlling the electromechanical actuating means, for example by current regulation, it is possible to subject the die means and the punch means to the action of a controlled and substantially constant force.

Furthermore, the die and/or the punch can perform even very short strokes with great precision.

The invention can be better understood and implemented with reference to the attached drawings that illustrate some embodiments thereof by way of non-limitative example, in which:

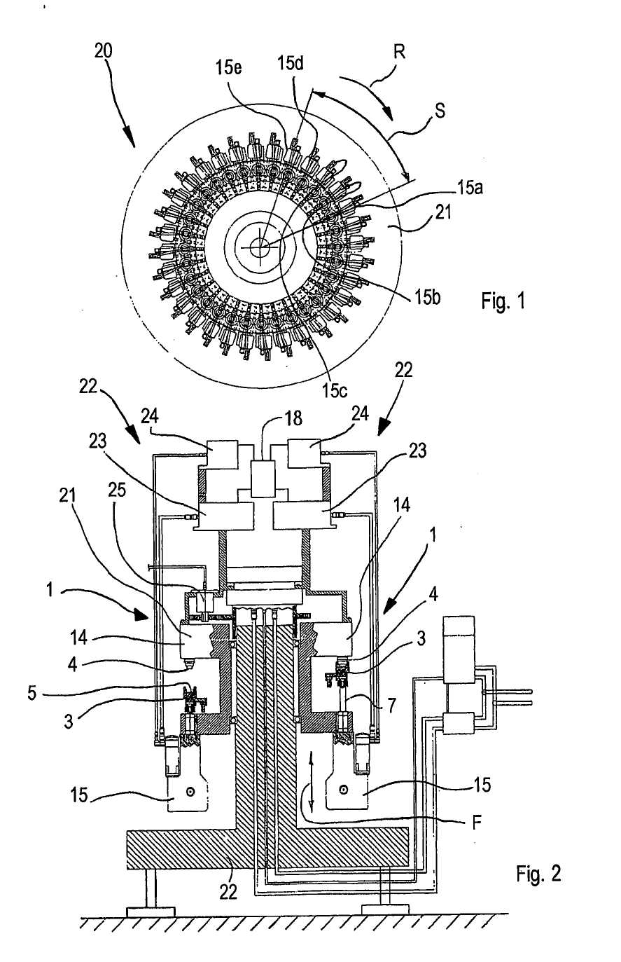

FIG. 1 is a plan view of an apparatus for moulding objects in plastics;

FIG. 2 is a schematic axial section of the apparatus in FIG. 2;

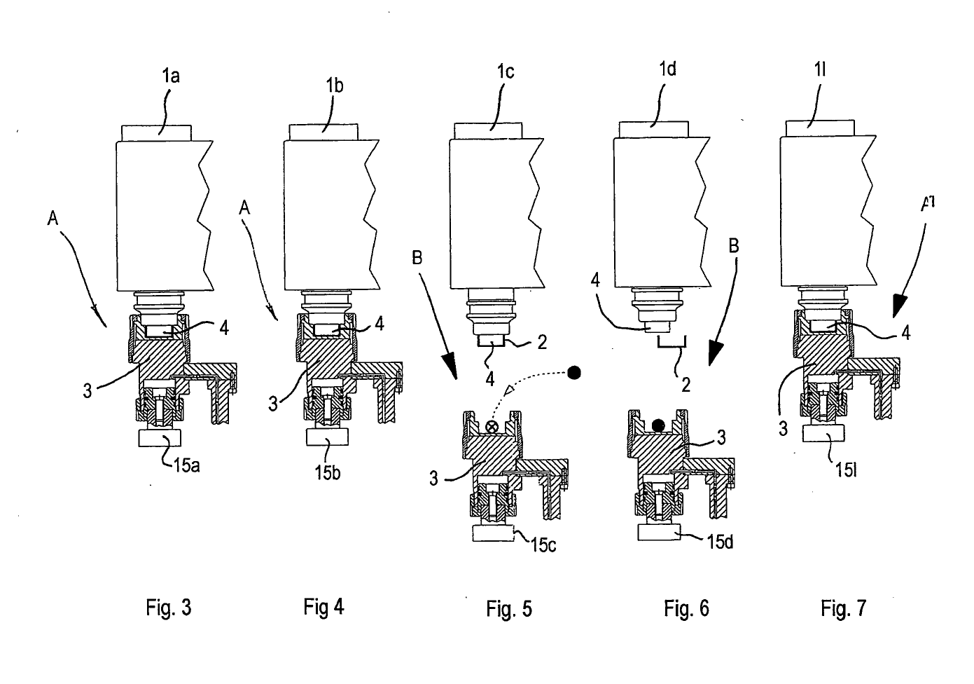

FIGS. 3 to 7 are schematic axial sections showing the positions of a plurality of moulds associated with rotatable turntable means of the apparatus in a given instant of operation of the apparatus;

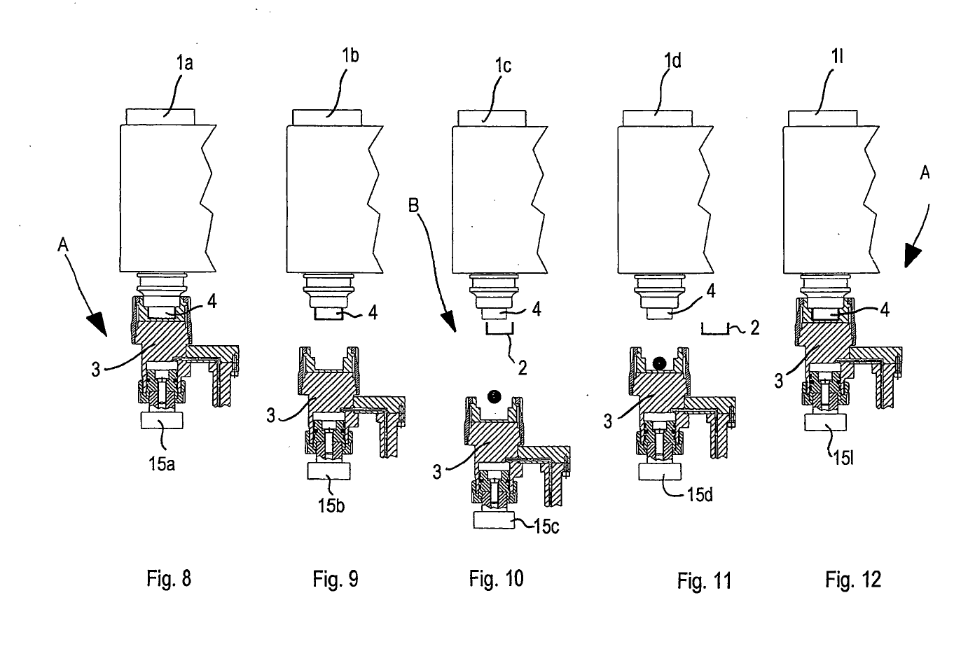

FIGS. 8 to 12 are schematic axial sections showing the positions of the moulds in FIGS. 3 to 7, after the turntable means has performed a rotation corresponding to half an advance step;

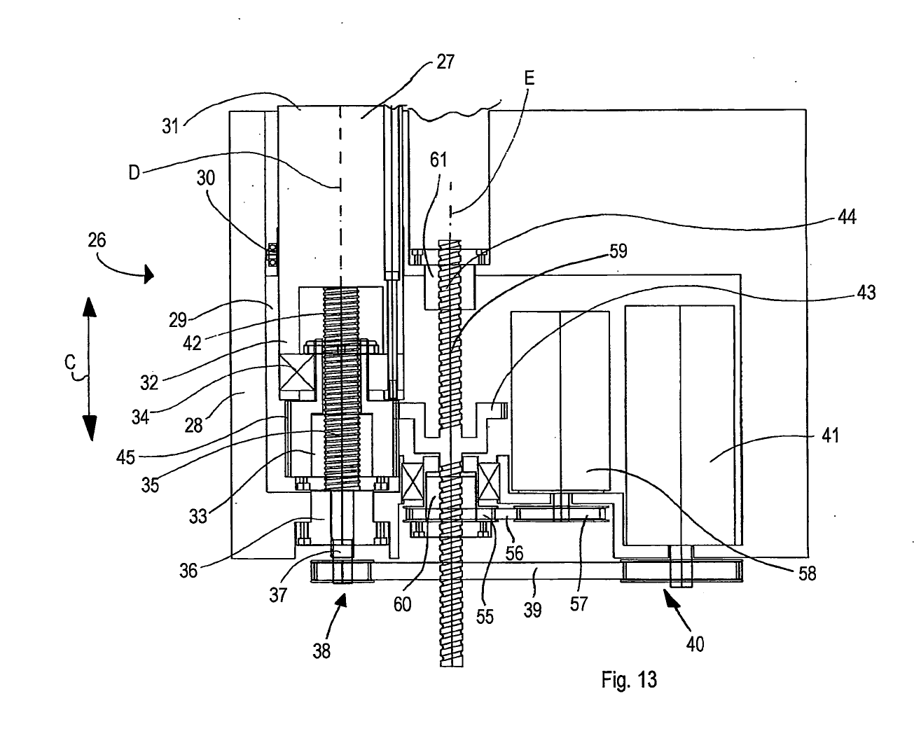

FIG. 13 is a schematic axial section of electromechanical actuating means of the apparatus in FIG. 1, shown in a first operating configuration;

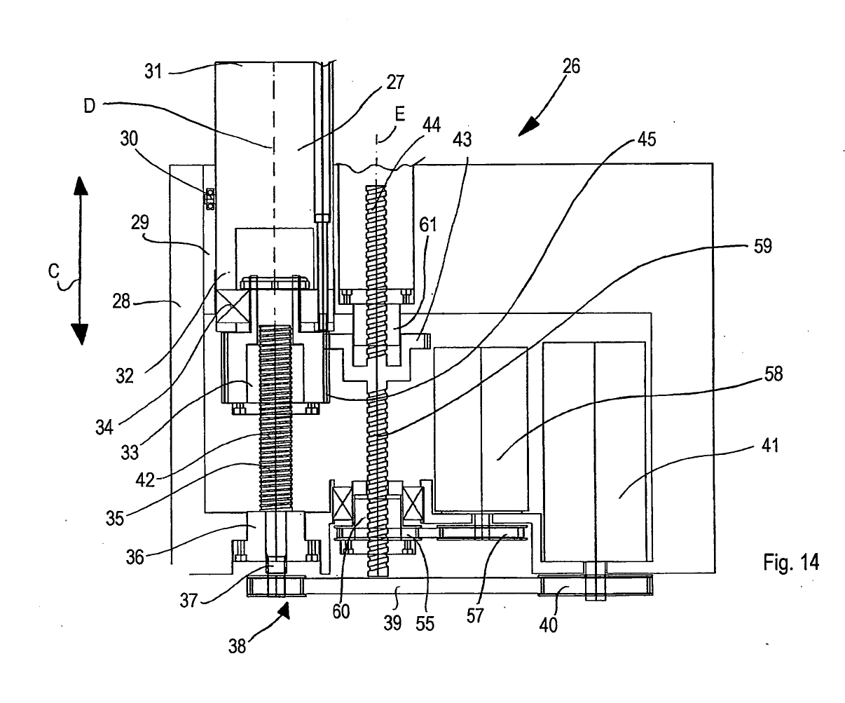

FIG. 14 is a section like the one in FIG. 13 showing the electromechanical actuating means in a second operating configuration;

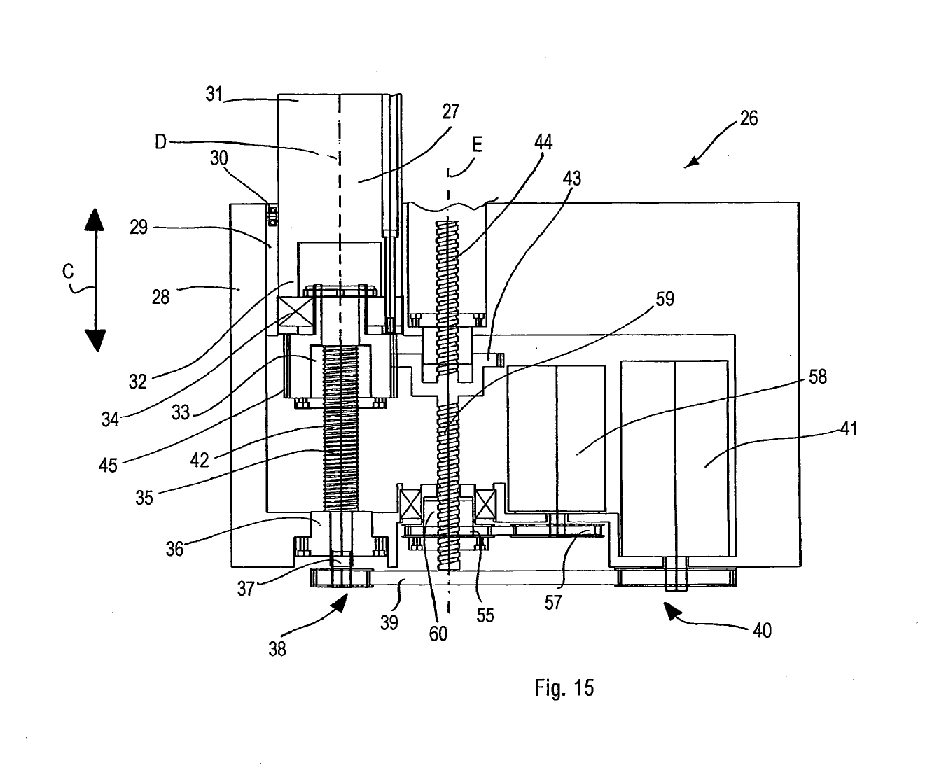

FIG. 15 is a section like the one in FIG. 13 showing the electromechanical actuating means in a third operating configuration;

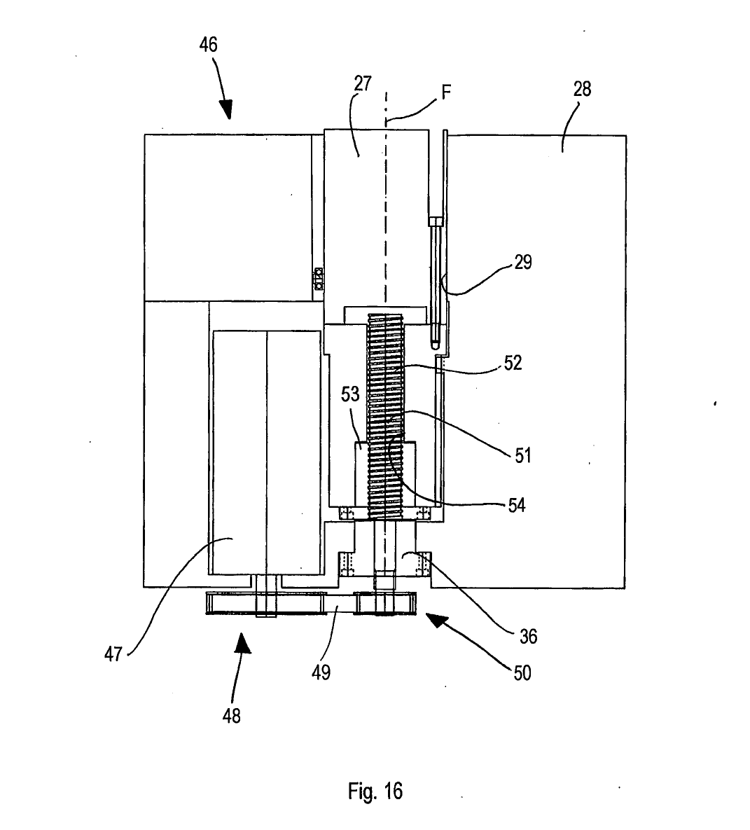

FIG. 16 is a section like the one in FIG. 13 showing further electromechanical actuating means, made according to a version, shown in a further first operating configuration;

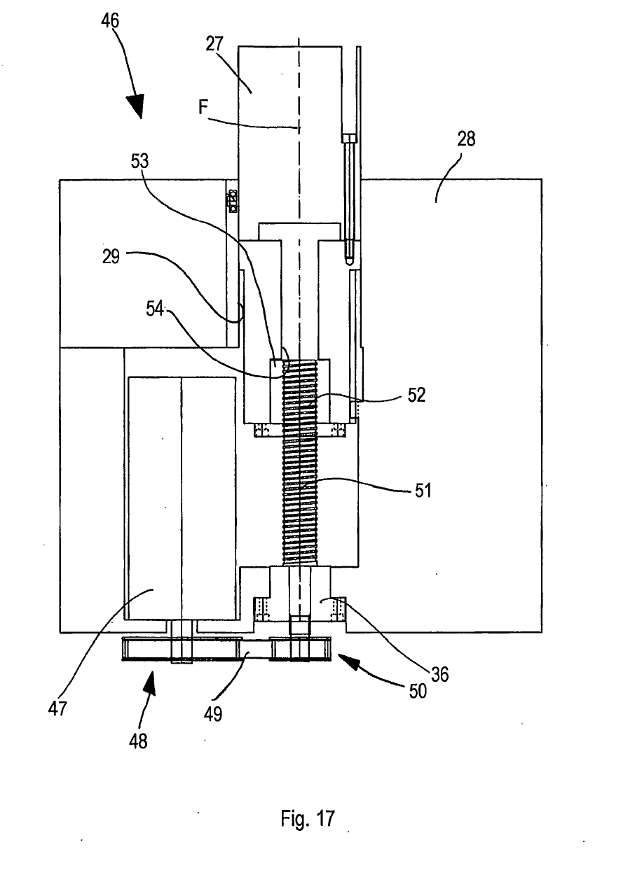

FIG. 17 is a section like the one in FIG. 13 showing the further electromechanical actuating means in FIG. 16 in a further second operating configuration;

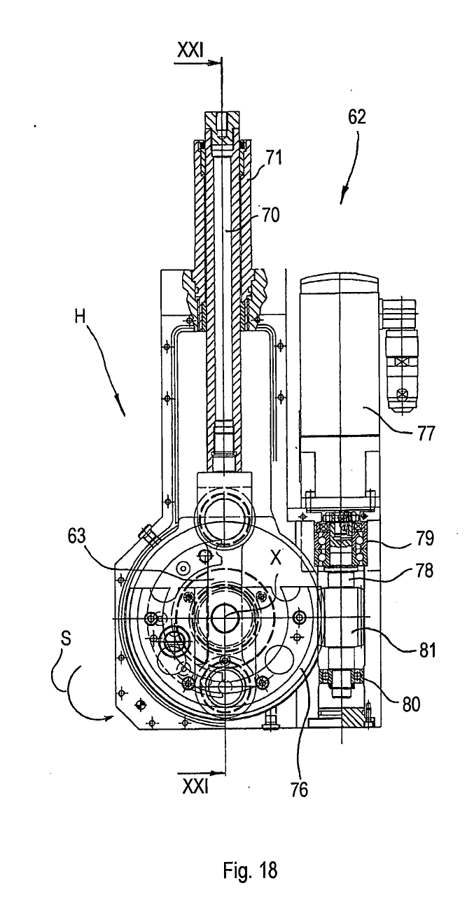

FIG. 18 is a schematic axial section showing still further electromechanical actuating means, made according to a version, shown in a still further first operating configuration;

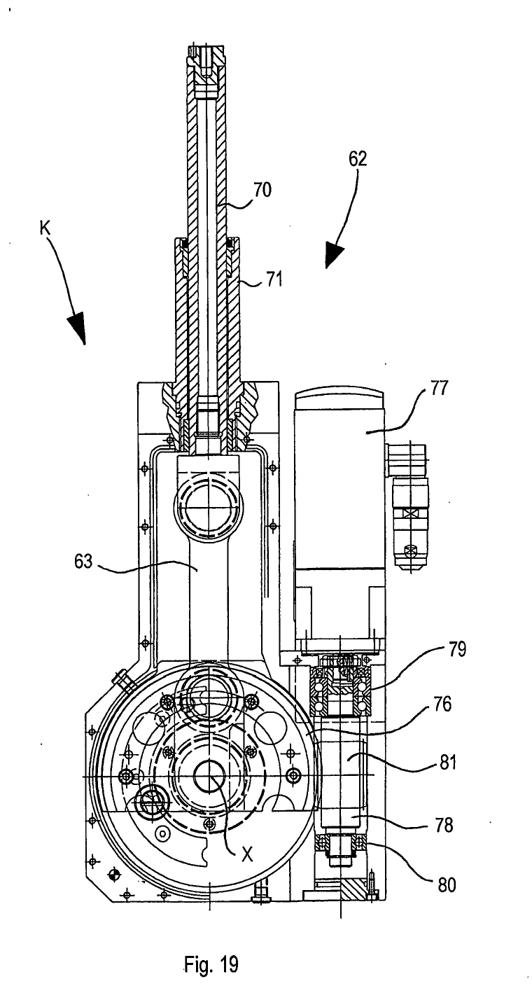

FIG. 19 is a section like the one in FIG. 18 showing the still further electromechanical actuating means in a still further second operating configuration;

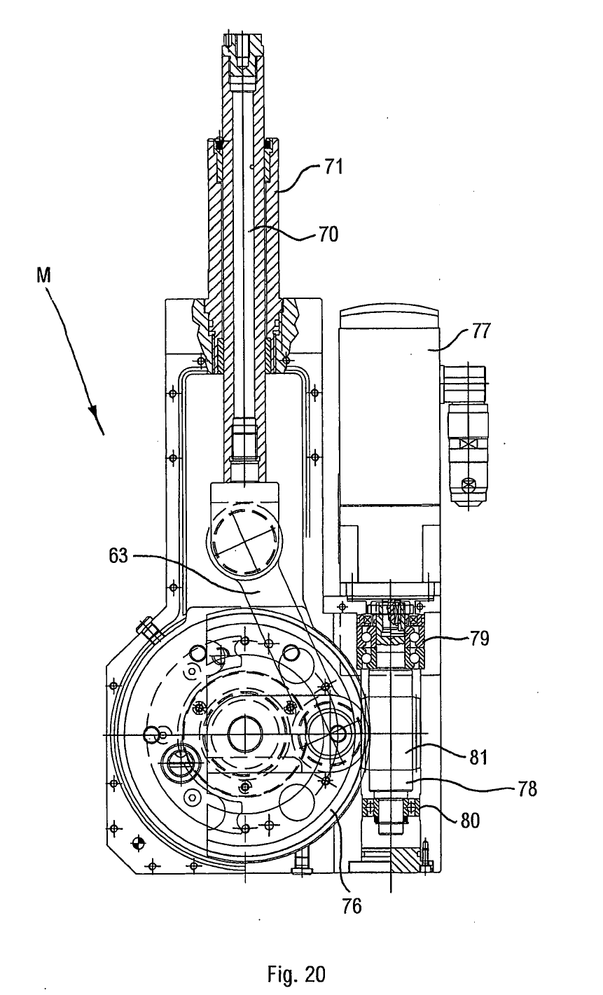

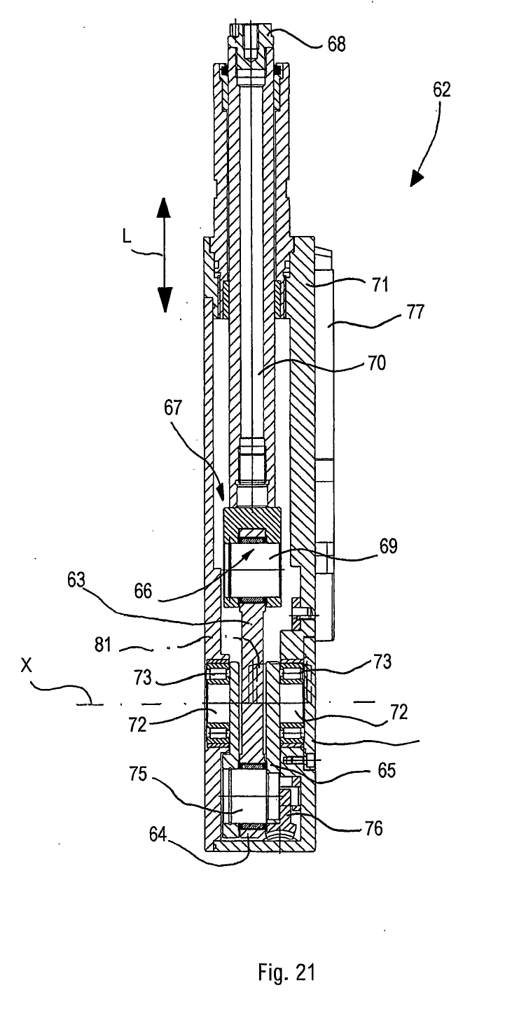

FIG. 20 is a section like the one in FIG. 18 showing the still further electromechanical actuating means in an intermediate operating configuration between the still further first operating configuration shown in FIG. 18 and the still further second operating configuration shown in FIG. 19;

FIG. 21 is a section taken along plane XXI-XXI di FIG. 18;

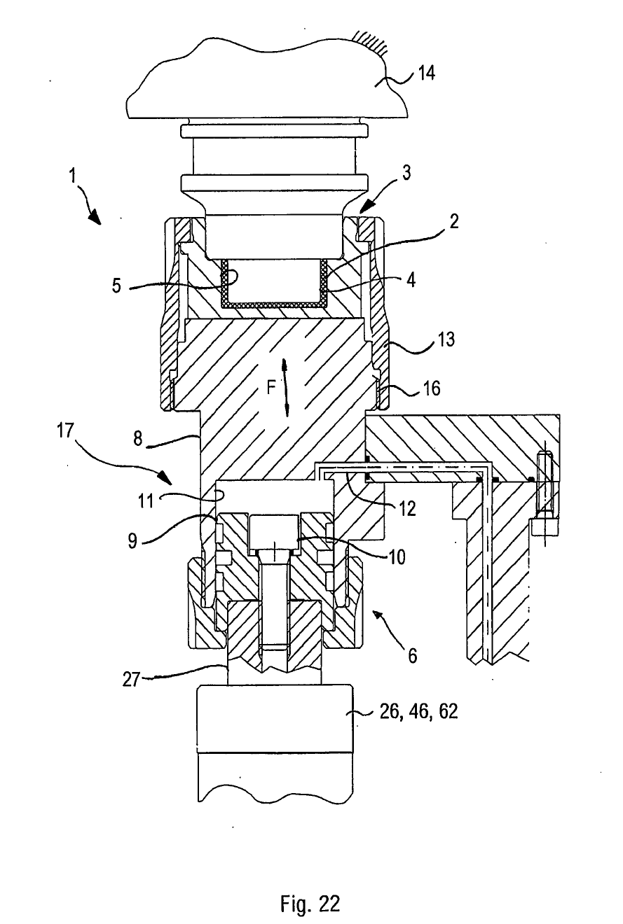

FIG. 22 is a schematic axial section showing mould means of the apparatus in FIG. 1.

With reference to FIGS. 1 to 12, there is shown an apparatus 20 for the compression moulding of plastics for obtaining caps 2, comprising a turntable 21 with which a plurality of moulds 1 is associated.

Each mould 1 comprises a die 3 provided with a cavity 5 suitable for defining an external surface of the caps 2, and a punch 4 arranged to press the plastics into the cavity 5 and suitable for defining an internal surface of the caps 2. The punch 4 is fixed to a support element 14 and remains stationary during operation of the mould 1.

Each mould 1 is associated with an actuating device 15, which will be disclosed in greater detail below, which controls, through a movable member 7, the movement of the die 3 towards and away from the punch 4, in the direction indicated by the arrow F.

The turntable 21 is rotatable in the direction indicated by the arrow R.

The moulds 1 are connected to the turntable 21 in such a way as to be arranged at angular distances of a constant amplitude.

With each mould 1a transducer—not shown—is furthermore associated that is arranged to detect the stroke performed by the movable member 7 of the actuating device 15, to which the die 3 is fixed.

FIGS. 3 to 7 show some of the moulds associated with the turntable 21, these moulds being indicated by the numeric references 1a, 1b, 1c, 1d, 1e.

Each mould 1a, 1b, 1c, 1d, 1e is provided with a respective actuating device 15a, 15b, 15c, 15d, 15e.

FIGS. 3 and 4 respectively show the moulds 1a, 1b in a closing position A, in which the plastics contained therein is moulded in such a way as to obtain a cap 2.

FIGS. 5 and 6 respectively show the moulds 1c and 1d in an opening position B in which a formed cap 2 is extracted from the respective mould, and a further dose of plastics in pasty state is inserted into the aforementioned mould.

Lastly, FIG. 7 shows the mould 1e in a subsequent closing position A1, corresponding to the closing position A.

Each mould 1 goes from the closing position A to the opening position B and then to the subsequent closing position A1 whilst the turntable 21 rotates by an angle of a preset amplitude.

Subsequently, each mould 1 is kept in the closing position A, A1 in such a way as to obtain, after moulding, stabilisation of the form of the cap 2 contained therein.

Alternatively, in the case of particular needs of the productive cycle, further rotation intervals of the turntable 21 can be provided during which the moulds 1 are opened and subsequently reclosed.

As for example occurs if a seal promoting element has to be associated with a formed cap 2, the seal promoting element comprises a disc in plastics that is positioned inside the cap in contact with a base wall off the latter.

FIGS. 8 to 12 show the moulds 1a, 1b, 1c, 1d, 1e after the turntable 21 has performed a half advance step.

In this configuration, the mould 1a is still in the closing position A, the mould 1b is being transferred from the closing position A to the opening position B, the mould 1c is in the opening position B, in which the cap 2 is removed from the punch 5 and a further dose of plastics is inserted inside the die 3, the mould 1d is being transferred from the opening position B to the closing position A1, the mould 1e, lastly, is in the closing position A1.

The apparatus 20 comprises a control unit 18 arranged to control the operation of the actuating devices 15.

The control unit 18 can be arranged in a remote position in relation to the actuating devices 15.

The control unit 18 may be a control logic unit.

Alternatively, a plurality of control units may be provided for controlling a larger number of actuating devices 15.

In other words, it is possible to provide a smaller number of control units than the number of actuating devices 15, instead of a control unit for each actuating device 15 as occurs in the known apparatuses.

In this case, each control unit can be dedicated to control a specific operation.

The apparatus furthermore comprises switching means 22 arranged to selectively connect each actuating device 15 to the control unit 18.

The apparatus can furthermore comprise supply means that is not shown arranged to supply the actuating devices 15, enabling its operation.

The supply means may comprise connectors and/or switches arranged to physically connect the actuators to delivery means of electric power.

The aforementioned connectors/switches also disconnect the actuators from the delivery means of electric power.

In other words, the supply means materially constitutes circuit components that connect and disconnect the actuators from the delivery means of electric power.

The actuation of the supply means—and consequently operation of the actuators—is managed by the control means to which the supply means is connectable by means of the switching means. In an embodiment, the supply means comprises a plurality of supply units, each supply unit being arranged in the proximity of a corresponding actuating device 15.

In this case, the switching means can selectively connect each supply unit to a respective actuating device 15.

In another embodiment, the supply means can comprise a single supply unit arranged in a remote position in relation to the actuating devices 15.

In particular, the supply unit can be integrated into the control unit 18.

Alternatively, the supply unit can be arranged in a remote position in relation to the control unit 18.

The switching means 22 comprises first switching means 23 suitable for selectively connecting the actuating devices 15 to the control unit 18 that regulates the supply of each actuating device 15.

The switching means 22 furthermore comprises second switching means 24 suitable for selectively connecting the transducers associated with the actuating devices 15 to the control unit 18.

The aforementioned transducers detect the stroke performed by the movable member 7 of each actuating device 15 and communicate it to the control unit 18 which, on the basis of this information, further operates the movable member 7 or stops it by intervening on the supply of the respective actuating device 15.

The apparatus furthermore comprises a position transducer 25 associated with the turntable 21 and suitable for communicating to the control unit 18 the position of the turntable 21 at each instant of the operating cycle.

The switching means 22 connects each actuating device 15 to the control unit 18 whereas the actuating device 15 performs, fixed relative to the turntable 21, a rotation corresponding to a preset angular interval.

In this case, each actuating device 15 is operated, during a period of time in which it travels, fixed relative to the turntable 21 said preset angular interval in such a way as to pass from an initial configuration to a final configuration.

The switching means 22 can simultaneously connect a group of actuating devices 15a, 15b, 15c, 15d, 15e rather than a single actuating device 15 to the control unit 18.

The group of actuating devices 15a, 15b, 15c, 15d, 15e can occupy a sector S of the turntable 1 having a certain angular amplitude.

The switching means 22 furthermore interrupts the connection between each actuating device 15 and the control unit 18 for a further interval of time during which the actuating device 15 travels, fixed relative to the turntable 21, a further angular interval of preset amplitude.

In this case, each actuating device 15 is not operated whilst the turntable 21 travels the angular interval and thus maintains the same configuration during the entire interval of time.

In an embodiment, the further angular interval corresponds to an angle that is substantially explementary to the angle corresponding to the aforementioned angular interval.

In other words, in this case each actuating device 15 is connected to the control unit 18 whilst it travels a certain angular interval, the connection thus being interrupted whilst the turntable 21 finishes making a revolution around its own axis.

Alternatively, for each revolution of the turntable 21, a plurality of active angular intervals can be provided during which each actuating device 15 can be operated between an initial configuration and a final configuration.

In this case, each actuating device 15 is connected to the control unit 18 whilst it traverses each of the active intervals.

The connection between each actuating device 15 and the control unit 18 is thus interrupted in each further interval interposed between two active consecutive intervals.

The apparatus 1 is provided with one or more control units that are able to control a greater number of actuating devices 15 owing to the presence of the switching means 22.

In this way, the apparatus 1 is much cheaper than the known apparatuses, inasmuch as it is not necessary to install a control unit for each actuating device.

As shown in FIGS. 13, 14 and 15, the actuating devices 15 may comprise electromechanical actuating devices 26.

The electromechanical actuating devices 26 are provided with a movable connecting body 27 at an end 31 of which the die 3 is fixed.

Similar electromechanical actuating devices can operate the punch 4 by means of a further connecting body.

The connecting body 27 is received in a space 29 obtained inside a housing 28 and is slidable in an advance direction C in such a way as to be able to be projected outside the housing 28 or be received inside it.

Between the housing 28 and the connecting body 27 guide means 30 is interposed that promotes and directs the slide of the movable connecting body 27 inside the housing 28.

The connecting body 27 is connected, at a second end 32 opposite the first end 31, to a lead nut 33.

With the lead nut 33 bearing means 34 is associated that enables the lead nut 33 to rotate around an axis D in relation to the movable connecting body 27.

The lead nut 33 is centrally provided with a threaded through hole that is coaxial to the axis D and engages with first screw means 35 provided with a first thread 42.

The first screw means 35 is arranged along the axis D inside the housing 28 and is rotatably connected to a support 36 so as to be rotatable around the axis D.

The first screw means 35 is provided with a protruding portion 37—not threaded—that projects through the support 36 outside the housing 28 and on which a first driven pulley 38 is splined. The first driven pulley 38 is connected by a first belt 39 to a first drive pulley 40 rotated by a first electric motor 41 installed inside the housing 28.

The lead nut 33 is peripherally provided with toothing 45 that engages with a toothed wheel 43 fixed relative to the second screw means 44.

The toothing 45 has an axial extent that is greater than the axial extent of the toothed wheel 43.

The second screw means 44 is provided with a second thread 59 having a pitch that is greater than the pitch of the first thread 42.

The second screw means 44 is arranged parallel to the first screw means 35.

The second screw means 44 is rotatable around a further axis E and can move along the latter when it is rotated.

The second screw means 44 is connected to a second driven pulley 55 which, by means of a second belt 56, is rotated by a second drive pulley 57 associated with a second electric motor 58.

The second screw means 44 interacts with a first lead nut element 60, fixed relative to the second driven pulley 55, and with a second lead nut element 61 arranged opposite the first lead nut element 60 in relation to the toothed wheel 43 and fixed to the housing 28.

During operation, the first electric motor 41 and the second electric motor 58 are actuated in such a way as to rotate respectively the first screw means 35 by the first driven pulley 38, and the first lead nut element 60 by means of the second driven pulley 55.

The first screw means 35, by rotating, forces the lead nut 33 and the connecting body 27 associated with it to move along the axis D.

The second screw means 44, actuated by the first lead nut element 60, moves along the further axis E in the same advance direction as the lead nut 33, and simultaneously rotates so that the toothed wheel 43 drags the lead nut 33 to rotate.

As a result, the lead nut 33 moves along the axis D and simultaneously rotates by screwing onto the first screw means 35.

The lead nut 33 advances along the axis D at an advance speed defined by two distinct components.

A first component is due to the movement given to the lead nut 33 by the first screw means 35 and a second component is due to the movement given to the lead nut 33 by the toothed wheel 43.

The advance speed thus depends on the geometry of the first thread 42, on the geometry of the second thread 59, on the rotation speed of the first motor means 41 and on the rotation speed of the second motor means 58.

When the connecting body 27 and the die 3 connected with it have performed a stroke of a preset amount, the second electric motor 58 is deactivated by stopping rotation of the first lead nut element 60.

The first electric motor 41, on the other hand, continues to rotate the first screw means 35, causing further movement of the lead nut 33 along the latter.

During the aforementioned further movement, the toothing 45 slides in relation to the toothed wheel 35.

The lead nut 33 shifts at a further advance speed having a value lower than the value of said advance speed, inasmuch as the further advance speed comprises solely a component due to the movement given to the lead nut 33 by the first screw means 35 and not also a further component due to the movement given to the lead nut 33 by the toothed wheel 43.

In operation, therefore, the die 3 is initially advanced at a great speed in such a way as to reduce the time required for closing and opening the mould 1 and, subsequently, at a reduced speed that enables the caps 2 to be moulded in an effective and precise manner, thus reducing blows and dynamic shocks.

With reference to FIGS. 16 and 17, there are shown electromechanical actuating devices 46, made according to a version.

The electromechanical actuating devices 46 comprise a housing 28 inside which an electric motor 47 is installed that rotates a drive pulley 48.

The drive pulley 48 is arranged outside the housing 28 and by means of a belt 49 actuates a driven pulley 50 that is fixed to screw means 51 provided with a thread 52.

The screw means 51 is rotatably connected to a support 36 so as to be rotatable around its own longitudinal axis F.

The thread 52 interacts with a further thread 54 obtained inside a lead nut element 53 fixed to a connecting body 27 that supports the die 3.

The lead nut element 53 is slidable along the axis F inside a cavity 29 obtained in the housing 28.

During operation, the electric motor 47, by means of the drive pulley 48 and the belt 49, rotates the driven pulley 50 and the screw means 51 connected thereto.

When the screw means 51 rotate, the thread 52 interacts with the further thread 54, forcing the lead nut element 53 to move along the axis F.

With reference to FIGS. 18 to 21, there are shown electromechanical actuating devices 62, made according to a further version.

The electromechanical actuating devices 62 comprise a connecting rod 63 having a first end 64 hinged on a crank pin 75 of a crankshaft 65 and a second end 66 hinged by means of a gudgeon 69 to an end 67 of a rod 70 provided with a further end 68 with which a die 3 of a mould 1 is associable, for example.

The rod 70 is partially received inside a sleeve 71 that acts as a guide element for guiding the movement of the rod 70 parallel to its longitudinal axis, as indicated by the arrow L.

The rod 70, therefore, actuated by the connecting rod 63—as will be explained in greater detail below—moves the die 3 towards and away from a respective punch 4.

The crankshaft 65 comprises a pair of pivots 72 rotatingly supported by respective bearings 73, on a casing 74 of the electromechanical actuating devices 62.

To the crank pin 75 a toothed sector 76 is fixed having an angular extent greater than 180°.

The toothed sector 76 is rotatable, as will be disclosed in greater detail below, around an axis X coinciding with the rotation axis of the pivots 72 of the crankshaft 65.

The electromechanical actuating devices 62 furthermore comprises a further electric motor 77 provided with control means arranged to control an electric parameter of the electric motor 77.

The electric motor 77 is provided with a shaft 78, supported by first bearing means 79 and by second bearing means 80, with which a screw gear 81 is associated that engages with the toothed sector 76.

FIG. 18 shows the rod 70 arranged in an operating configuration H, corresponding to the lower dead point, in which the die 3 is distanced from the corresponding punch 4 to enable the picking up of a formed object and the insertion inside the die 3 of a dose of plastics.

FIG. 19 shows the rod 70 arranged in a further operating configuration K, corresponding to the upper dead point, in which the die 3 cooperates with the respective punch 4 to perform the moulding of an object.

The rod 70 is kept in the further operating configuration K even after moulding of the object to enable cooling and stabilisation of the form of the object.

In operation, when the further electric motor 77 is rotated in a preset direction, the toothed sector rotates in the direction indicated by the arrow S, so that the rod 70 is transferred from the operating configuration H to the further operating configuration K.

Once the phases of moulding, cooling and stabilisation of the form of an object have terminated, the electric motor 77 is rotated in a direction opposite the aforementioned preset direction, causing a corresponding rotation of the toothed sector 76 in a direction opposite that indicated by the arrow S. In this way, the rod 70 is returned to the operating configuration H.

The electromechanical actuating devices 62 enable the rod 70—and therefore the die 3, or the punch 4 that is associated therewith—to be operated at a variable speed. In particular, the electromechanical actuating devices 62 enable a low speed to be obtained—and a high moulding force—at a final phase of the stroke of the rod 70, and a high speed at an intermediate phase of the stroke of the rod 70, thus ensuring rapid closure of the mould 1.

The speed of the die 3, or of the punch 4, is particularly high in the vicinity of a still further operating configuration M, shown in FIG. 20, in which the cranking is in the squaring position.

Furthermore, the use of a screw gear 81 cooperating with the toothed sector 76 enables electromechanical actuating devices 62 that are substantially mechanically irreversible to be obtained, in particular at the upper dead point.

This enables the rod 70 to be maintained in the further operating configuration K—and thus with the mould closed—without the need to uninterruptedly supply the further electric motor 77.

In this way, the electric motor 77 and the respective control means are not stressed during the course of the phases of cooling and stabilisation of the form of an object, such phases being the longest-lasting in a work cycle of the apparatus.

Furthermore, the interposition between the rod 70 and the die 3, or the punch, of shock-absorbing means, which will be disclosed in greater detail below, enable a force to be exerted on the object contained in the mould during the phases of cooling and stabilisation of the form that is substantially constant despite the shrinkage due to cooling of the material with which the object was formed.

With reference to FIG. 22, there is shown a mould 1 for the moulding of objects in plastics, for example caps 2.

The mould 1 comprises a die 3 provided with a cavity 5 suitable for defining an external surface of the caps 2, and a punch 4 arranged to press the plastics in the cavity 5 and suitable for a defining an internal surface of the caps 2. The punch 4 is fixed relative to a support element 14 and remains stationary during operation of the mould 1.

The mould 1 is connected at one of its ends to an actuating device, for example an electromechanical actuating device 26, 46, 62.

The electromechanical actuating device 26, 46, 62 controls the movement of the die 3 towards and away from the punch 4 in the direction indicated by the arrow F. At a free end 6 of a connecting body 27 of the electromechanical actuating device 26, 46, 62 there is fixed a head 9 by means of a screw 10.

The head 9 is slidable inside a chamber 11 obtained in a base 8 of the die 3.

The die 3 is connected to the base 8 by a threaded ring nut 13 that engages in a corresponding threat 16 obtained in a base zone B opposite a further zone of the base 8 in which the chamber 11 is obtained.

In the base 8 a conduit 12 is furthermore obtained that is arranged to connect the chamber 11 with an external environment, in particular with a system for supplying pressurised fluid, for example a gaseous fluid, in particular air.

With the conduit 12 a maximum pressure conduit can be associated, that is not shown, that is arranged to enable the escape of the fluid from the chamber 11 if the pressure of the fluid has reached a preset threshold value.

The chamber 11, the conduit 12 and the pressurised fluid act as shock-absorbing means 17 arranged to prevent excessively energetic interaction of the die 3 with the punch 4.

In an embodiment that is not shown, the electromechanical actuating device 26, 46, 62 moves the punch 4 to and away from the die 3, which remains stationary during operation of the mould 1.

In this case, the shock-absorbing means 17 is positioned between the electromechanical actuating device 26, 46, 62 and the punch 4.

In a further embodiment that is not shown the electromechanical actuating device 26, 46, 62 operates the die 3, whilst the punch 4 remains fixed.

In this case, the shock-absorbing means 17 is interposed between the punch 4 and the support element 14 rather than between the die 3 and the electromechanical actuating device 26, 46, 62.

The shock-absorbing means 17 enables a virtually constant force to be maintained on the mould during the cooling phase of the objects, in particular, owing to the action of the pressurised fluid, the objects are maintained pressed despite the shrinkage caused by cooling of the plastics.

The shock-absorbing means 17, when associated with mechanically irreversible electromechanical actuating devices (at least in the configurations near the upper dead point), enable the motor means to be kept inactive with which the electromechanical actuating devices are provide during the entire cooling phase. This enables the mechanical and electronic components of the apparatus not to be unnecessarily stressed.

Electromechanical actuating devices cooperating with shock-absorbing means 17 are particularly suitable for being used in combination with the control unit or units 18 and the switching means 22 disclosed with reference to FIGS. 1 to 12.

In this case, in fact, the switching means 22 can connect the electromechanical actuating devices to the control unit, or units 18, during the phase of supply of the mould with plastics and during the moulding phase.

Subsequently, the switching means 22 can disconnect the electromechanical actuating devices from the control unit, or units 18, during the cooling phase, an appropriate clamping force being generated on the mould, in this operating configuration, by the shock-absorbing means 17.

Alternatively, the shock-absorbing means may not be provided, This is so in cases in which the electromechanical actuating devices are of the high-performance type.

In this case, electric motor means with which the electromechanical actuating devices are provided may be controlled whilst powered up in order to exert a controllable force on the mould 1.

In an embodiment, the electromechanical actuating devices may comprise mechanically reversible electromechanical actuating devices that comprise a motion inlet and a motion outlet that can be mutually reversed during operation.

1-82. (canceled)

83. Apparatus for moulding plastics, comprising a mould device, an actuating system arranged to move said mould device and a shock-absorbing device interposed between said actuating system and said mould device, wherein said actuating system comprises an electromechanical actuating system.

84. Apparatus according to claim 83, wherein said electromechanical actuating system comprises an electric motor unit and a control system for controlling an electrical parameter of said electric motor unit.

85. Apparatus according to claim 84, wherein said control system comprises an adjusting system for current controlling said electric motor unit.

86. Apparatus according to claim 83, wherein said electromechanical actuating system comprises a motion inlet and a motion outlet and is shaped in such a way that during use said motion inlet and said motion outlet are mutually reversible.

87. Apparatus according to claim 83, wherein said electromechanical actuating system comprises a connecting rod device provided with a first end connectable to a crank device and with a second end connectable to said mould device.

88. Apparatus according to claim 84, wherein said electromechanical actuating system comprises a connecting rod device provided with a first end connectable to a crank device and with a second end connectable to said mould device.

89. Apparatus according to claim 87, and furthermore comprising a motor arranged to rotate said crank device.

90. Apparatus according to claim 88, and furthermore comprising a motor arranged to rotate said crank device.

91. Apparatus according to claim 90, wherein said electric motor unit comprises said motor.

92. Apparatus according to claim 87, wherein said crank device comprises a crankshaft comprising a pair of pivots rotatably supported by a casing of said apparatus.

93. Apparatus according to claim 87, wherein said crank device comprises a crank pin on which said connecting rod device is hinged at said first end.

94. Apparatus according to claim 92, wherein said crank device comprises a crank pin on which said connecting rod device is hinged at said first end.

95. Apparatus according to claim 93, and furthermore comprising a gear device associated with said crank pin.

96. Apparatus according to claim 94, and furthermore comprising a gear device associated with said crank pin.

97. Apparatus according to claim 95, wherein said gear device is coaxial to said pivots.

98. Apparatus according to claim 95, wherein said gear device comprises a toothed sector fixed relative to said crank pin.

99. Apparatus according to claim 95, and furthermore comprising a further gear device cooperating with said gear device.

100. Apparatus according to claim 96, and furthermore comprising a further gear device cooperating with said gear device.

101. Apparatus according to claim 100 wherein said further gear device is rotatable by said motor.

102. Apparatus according to claim 100, wherein said further gear device comprises a screw gear.

103. Apparatus according to claim 87 and furthermore comprising a connecting system interposed between said connecting rod device and said mould device.

104. Apparatus according to claim 103, wherein said connecting system comprises a rod device provided with an end connectable to said second end) and with a further end connectable to said mould device.

105. Apparatus according to claim 104, and furthermore comprising a sleeve member suitable for partially surrounding said rod device to enable said rod device to move substantially parallel to its longitudinal axis.

106. Apparatus according to claim 84, wherein said electromechanical actuating system comprises a screw device cooperating with a lead nut device.

107. Apparatus according to claim 106, and furthermore comprising a motor arranged to rotate said screw device.

108. Apparatus according to claim 107, wherein said electric motor unit comprises said motor.

109. Apparatus according to claim 106, and furthermore comprising a connecting system interposed between said lead nut device and said mould device.

110. Apparatus according to claim 106, wherein said electromechanical actuating system comprises further screw device to which a toothed wheel device is relatively fixed.

111. Apparatus according to claim 110, wherein said screw device comprises a thread having a pitch that is less than the pitch of a further thread with which said further screw device is provided.

112. Apparatus according to claim 110, wherein said further screw device comprises a first portion arranged to engage in a further lead nut device and a second portion arranged to engage in still further lead nut device.

113. Apparatus according to claim 112, wherein said further lead nut device is rotatable by a further motor.

114. Apparatus according to claim 113, wherein said electric motor unit comprises said further motor.

115. Apparatus according to claim 112, wherein a still further lead nut device is fixed relative to a support structure of said apparatus.

116. Apparatus according to claim 111, wherein said toothed wheel device is shaped in such a way as to engage with a toothed device obtained in an external portion of said lead nut device.

117. Apparatus according to claim 116, wherein said toothed device and said toothed wheel device are shaped in such a way as to allow axial sliding of said lead nut device in relation to said toothed wheel device.

118. Apparatus according to claim 106, wherein said lead nut device is rotatingly coupled with an element supporting said mould device, by a bearing system.

119. Apparatus according to claim 83, wherein said shock-absorbing device comprises a chamber unit arranged to receive at least one fluid substance.

120. Apparatus according to claim 119, wherein said chamber unit (11) is delimited by a base element supporting said mould device and by a head element fixed relative to a relinquishing device of said actuating system.

121. Apparatus according to claim 120, wherein said head device is slidable inside said base element.

122. Apparatus according to claim 120, wherein in said base element a conduit system is obtained arranged to enable said at least one fluid substance to flow into and out of said chamber unit.

123. Apparatus according to claim 119, wherein said at least one fluid substance comprises a fluid compatible with said plastics.

124. Apparatus according to claim 119, wherein said at least one fluid substance comprises air.

125. Apparatus according to claim 83, wherein said actuating system comprises a plurality of actuating devices suitable for operating said mould device between a neutral position and an operating position.

126. Apparatus according to claim 125, and furthermore comprising at least one control unit to control said actuating devices and a switching device arranged to selectively connect said at least one control unit to at least an actuating device of said plurality of actuating devices.

127. Apparatus according to claim 126, wherein said at least one control unit comprises a plurality of control units less numerous than said plurality of actuating devices.

128. Apparatus according to claim 127, wherein each control unit of said plurality of control units controls a preset operation of said at least one actuating device.

129. Apparatus according to claim 126, wherein said at least one control unit is arranged in a remote position in relation to said actuating devices.

130. Apparatus according to claim 126, wherein said at least one control unit is a control logic unit.

131. Apparatus according to claim 126, and furthermore comprising at least a supply unit to connect said actuating devices to an electric power delivery unit.

132. Apparatus according to claim 131, wherein said at least one supply unit is arranged in a remote position in relation to said actuating devices.

133. Apparatus according to claim 131, wherein said at least one supply unit is integrated into said at least one control unit.

134. Apparatus according to claim 131, wherein said at least one supply unit is arranged in a remote position in relation to said at least one control unit.

135. Apparatus according to claim 131, wherein said at least one supply unit comprises a plurality of supply unit, each supply unit of said plurality of supply unit being arranged near a respective actuating device of said plurality of actuating devices.

136. Apparatus according to claim 135, wherein said switching device selectively connects said each supply unit to said respective actuating device.

137. Apparatus according to claim 126, and furthermore comprising a rotatable turntable device with which is associated said mould device said mould device being movable during rotation of preset angular amplitude of said rotatable turntable device, between said neutral position and said operating position.

138. Apparatus according to claim 137, wherein said at least one actuating device comprises a group of actuating devices that occupies a sector of said turntable device).

139. Apparatus according to claim 137, wherein said at least one actuating device comprises a plurality of groups of actuating devices that occupy angularly consecutive sectors of said turntable device.

140. Apparatus according to claim 137, wherein said switching device connects said at least one actuating device to said at least one control unit for an interval of time during which said at least one actuating device performs, connected to said turntable device, said rotation of a preset angular amplitude.

141. Apparatus according to claim 137, wherein said switching device interrupts the connection between said at least one actuating device and said at least one control unit for a further interval of time during which said at least one actuating device performs, fixedly relative to said turntable device, a further rotation of a preset angular amplitude.

142. Apparatus according to claim 139, wherein said further rotation corresponds to an angle substantially explementary to the angle corresponding to said rotation of a preset angular amplitude.

143. Apparatus according to claim 126, and furthermore comprising further switching device arranged to connect to said at least one control unit a transducer device arranged to detect the movement of a movable member of said at least one actuating device.

144. Apparatus according to claim 126, and furthermore comprising a further transducer device arranged to detect the angular position of said at least one actuating device (and to communicate said angular position to said at least one control unit.

145. Apparatus according to claim 126, wherein said operating unit comprises a mould device for the compression moulding of plastics.

146. Apparatus for moulding plastics, comprising a mould device and an actuating system arranged to move said mould device, wherein said actuating system comprises an electromechanical actuating system provided with an electric motor unit and with a control system for controlling an electrical parameter of said electric motor unit.

147. Apparatus according to claim 146, wherein said control system comprises an adjusting system for current controlling said electric motor unit.

148. Apparatus according to claim 146, and furthermore comprising a shock-absorbing device interposed between said actuating system and said mould device.

149. Operating machine, comprising a plurality of actuating devices suitable for operating an operating unit between a neutral position and an operating position, a control system for controlling said actuating devices, wherein said control system comprises at least one control unit, there being provided a switching device arranged to selectively connect said at least one control unit to at least an actuating device of said plurality of actuating devices.

150. Machine according to claim 149, wherein said at least one control unit comprises a plurality of control units less numerous than said plurality of actuating devices.

151. Machine according to claim 150, wherein each control unit of said plurality of control units controls a preset operation of said at least one actuating device.

152. Machine according to claim 149, wherein said at least one control unit is arranged in a remote position in relation to said actuating devices.

153. Machine according to claim 149, wherein said at least one control unit is a control logic unit.

154. Machine according to claim 149, and furthermore comprising at least a supply unit to connect said actuating devices to an electric power delivery unit.

155. Machine according to claim 154, wherein said at least one supply unit is arranged in a remote position in relation to said actuating devices.

156. Machine according to claim 154, wherein said at least one supply unit is integrated into said at least one control unit.

157. Machine according to claim 154, wherein said at least one supply unit is arranged in a remote position in relation to said at least one control unit.

158. Machine according to claim 154, wherein said at least one supply unit comprises a plurality of supply units, each supply unit of said plurality of supply units being arranged near a respective actuating device of said plurality of actuating devices.

159. Machine according to claim 158, wherein said switching device selectively connects said each supply unit to said respective actuating device (15).

160. Machine according to claim 149, and furthermore comprising a rotatable turntable device with which is associated said operating unit, said operating unit being movable during rotation of preset angular amplitude of said rotatable turntable device, between said neutral position and said operating position.

161. Machine according to claim 160, wherein said at least one actuating device comprises a group of actuating devices that occupies a sector of said turntable device.

162. Machine according to claim 160, wherein said at least one actuating device comprises a plurality of groups of actuating devices that occupy angularly consecutive sectors of said turntable device.

163. Machine according to claim 160, wherein said switching device connects said at least one actuating device to said at least one control unit for an interval of time during which said at least one actuating device performs, fixedly relative to said turntable device, said rotation of a preset angular amplitude.

164. Machine according to claim 160, wherein said switching device interrupts the connection between said at least one actuating device and said at least one control unit for a further interval of time during which said at least one actuating device performs, fixedly relative to said turntable device, a further rotation of a preset angular amplitude.

165. Machine according to claim 164, wherein said further rotation corresponds to an angle substantially explementary to the angle corresponding to said rotation of a preset angular degree.

166. Machine according to claim 149, and furthermore comprising a further switching device arranged to connect to said at least one control unit a transducer device arranged to detect the movement of a movable member of said at least one actuating device.

167. Machine according to claim 149, and furthermore comprising a further transducer device arranged to detect the angular position of said at least one actuating device and communicating said angular position to said at least one control unit.

168. Machine according to claim 149, wherein said mould device comprises a die device.

169. Machine according to claim 149, wherein said mould device comprises a punch device.
